(19) United States
(12) Patent Application Publication
(10) Pub. No.: US 2025/0004097 A1
(43) Pub. Date: Jan. 2, 2025

(54) RADAR MEASURING DEVICE FOR DETERMINING FILL LEVELS AND/OR DISTANCES

(71) Applicant: VEGA Grieshaber KG, Wolfach (DE)

(72) Inventors: Christian WEINZIERLE, Wolfach (DE); Steffen WAELDE, Niedereschach (DE)

(73) Assignee: VEGA Grieshaber KG, Wolfach (DE)

(21) Appl. No.: 18/746,603

(22) Filed: Jun. 18, 2024

(30) Foreign Application Priority Data
Jun. 30, 2023 (EP) 23 182 603.3

(51) Int. Cl. G01S 7/03; G01F 23/284; G01S 7/02

(52) U.S. Cl. CPC G01S 7/032; G01F 23/284; G01S 7/023

(57) ABSTRACT

A radar measuring device for determining fill levels and/or distances is provided, including: a primary radiator configured to transmit and to receive radar signals; an antenna configured to transmit and to receive radar signals; and a filter configured to filter the radar signals, the filter being arranged between the primary radiator and the antenna. A system for detecting filling levels and/or distances is also provided, including the radar measuring device and a container configured to store a material.

### CROSS-REFERENCE TO RELATED APPLICATIONS

This application claims the benefit of priority under 35 U.S.C. § 119 from European Patent Application No. 23 182 603.3 filed on 30 Jun. 2023, the entire content of which is incorporated herein by reference.

### TECHNICAL FIELD

The present disclosure relates to a radar measuring device for determining fill levels and/or distances and to a system for determining fill levels and/or distances.

### BACKGROUND

Radar measuring devices are used, for example, in the process and chemical industries to monitor (determine) fill levels in containers.

In this context, it has now become apparent that there is a further need to provide a radar measuring device for determining fill levels and/or distances, in particular there is a need to provide an accurate and efficient radar measuring device for determining fill levels and/or distances.

These and other objects, which will be mentioned when reading the following description or which can be recognized by the skilled person, are solved by the subject matter of the independent claims. The dependent claims relate to further aspects of the present disclosure in a particularly advantageous manner.

### SUMMARY

According to a first aspect of the present disclosure, there is provided a radar measuring device for determining (detecting) levels and/or distances, comprising: a primary radiator for transmitting and receiving radar signals; an antenna unit for transmitting and receiving radar signals; a filter unit for filtering the radar signals, the filter unit being arranged between the primary radiator and the antenna unit.

The term primary radiator is to be understood broadly in the present case and means a structural element which is configured to radiate electromagnetic waves, preferably radar signals, which are generated by a circuit, preferably a high-frequency circuit in the GHz range, and/or to receive reflected radar signals. The primary radiator can be designed in one or more parts. The primary radiator can be arranged at least partially on the high-frequency circuit for generating the radar signals and for processing reflected radar signals.

The term radar measuring device is to be understood broadly in the present case and preferably means a measuring device for determining fill levels and/or distances, whereby the measuring device determines the fill level or distance according to the principle of transit time measurement of the radar signals. The radar measuring devices are used, for example, in containers to detect the fill level and/or a distance. A level to be measured in the container is determined taking into account the position of the radar measuring device and the measured transit time between transmitted radar signals and received radar signals, i.e., radar signals reflected by the surface, e.g., of a bulk material in a container. Different methods can be used to determine the transit times, e.g., pulse radar or frequency modulation continuous wave radar. Alternatively, the radar measuring device can also be referred to as a radar level measuring device.

The term antenna unit is to be understood broadly here and means a structural element that is configured to transmit and receive radar signals. The antenna unit can be designed as a horn antenna. The antenna unit can be designed as a dielectric lens. The antenna unit preferably transmits the radar signals to a surface and receives the radar signals reflected by the surface.

The term filter unit is to be understood broadly here and means a structural passive element that is configured to filter frequencies of a signal, preferably the radar signal, below a cut-off frequency, above a cut-off frequency or between two cut-off frequencies. The filter unit can be designed in one or more parts. The filter unit preferably has a high-pass characteristic. The filter unit can have a low-pass characteristic. The filter unit can have a band-pass characteristic. The filter unit preferably blocks individual modes of the radar signal generated by the high-frequency circuit. For example, the high-frequency circuit first generates a basic signal (e.g., 40 GHz). A multiplier multiplies this by an integer to the desired frequency or associated mode (e.g., 240 GHz). The filter unit now preferably filters the fundamental mode at 40 GHz and the corresponding higher-order modes at 80 GHz, 120 GHz, 160 GHz, 200 GHz, which also occur, so that only the desired mode at the frequency at 240 GHz can pass through the filter. Preferably, the filter unit also filters higher unwanted modes or frequencies (e.g., 280 GHz and 320 GHz). The filter unit can also advantageously specify the polarization of the radar signals.

The present disclosure is based on the realization that in radar measuring devices that are operated above 100 GHz, the radar signals are fed directly from the high-frequency circuit into the waveguide, for example a hollow conductor, or, for example, a dielectric waveguide. Below an operating frequency of 100 GHz, however, the radar signal is usually first routed via a printed circuit board before being fed into a waveguide. The transition from the printed circuit board (i.e., carrier board) to the waveguide is designed in such a way that the desired mode/frequency is set in the waveguide and unwanted modes/frequencies (i.e., interference signals) are filtered out. The present disclosure solves this problem by means of a filter unit that is integrated in the radar measuring device and thus enables interference frequencies to be filtered even at operating frequencies above 100 GHz. This has an advantageous effect on the measurement quality and accuracy of the level measurement and/or distance measurement.

Modern radar measuring devices for the process industry and automation technology are now gradually opening up the frequency range above 100 GHz. Due to the emergence of new frequency regulations, ever-improving semiconductor processes and more precise manufacturing methods, radar-based level measuring devices up to 250 GHz can be developed, produced, and marketed. Higher frequency ranges have the advantage that a narrower aperture angle can be realized with the same antenna size. The agitators or heating coils installed in containers often generate interference reflections in the radar signal, but these are reduced or even disappear with a smaller aperture angle of the antenna.

From a regulatory point of view, a wider signal bandwidth is also permissible in higher frequency ranges, which means that two neighboring radar targets can be better separated. This presents new challenges for developers of radar measurement technology compared to today's established 80 GHz technology.

One example is hollow conductors, which are mainly used in 80 GHz sensors to transmit the radar signal from the radar module to the antenna. The hollow conductors, which in this case are mainly designed as round hollow conductors, have a diameter of between 2.5 and 3.0 mm in this frequency range and can be produced comparatively cheaply in a sufficient length using deep-hole drilling processes. The length of the hollow conductor is of fundamental importance with regard to temperature decoupling between the process to be monitored and the sensor electronics. The sensor electronics must not exceed a temperature of 85° C., whereas the process temperature can be up to 450° C. Temperature decoupling can be achieved using long hollow conductors.

As the frequencies increase, the hollow conductor diameters become increasingly smaller, as the cut-off frequency of the fundamental mode depends on the hollow conductor diameter. For a 250 GHz radar signal, the hollow conductor diameter is only 0.87 mm. With such a small diameter, it is considerably more complex to manufacture a hollow conductor of the same length than with a hollow conductor diameter of 80 GHz. Rectangular hollow conductors are rather untypical for radar level meters as they are more complex to manufacture.

The cut-off frequency is the frequency above which the fundamental mode of the hollow conductor is capable of propagation. If the signal frequency is below the cut-off frequency, no signal transmission takes place as the electromagnetic wave is not capable of propagation. In this case, the wave is reflected at the input of the hollow conductor. A hollow conductor therefore exhibits high-pass behavior.

Higher order modes than the fundamental mode also have cut-off frequencies, but these are higher than the cut-off frequency of the fundamental mode. For radar level meters, it is always advantageous to operate the hollow conductor in such a way that it is operated in the fundamental mode. Higher order modes have different propagation speeds in the hollow conductor than the fundamental mode, which can lead to incorrect measurements.

Another difference between the rectangular hollow conductor and the round hollow conductor is that the polarization of the electromagnetic wave is predetermined in the rectangular hollow conductor. The electric field vector is parallel to the short edge of the hollow conductor. In the round hollow conductor, on the other hand, the polarization is arbitrary and depends on how the wave is coupled into the hollow conductor. Depending on the type of application, this can have advantages and disadvantages.

Another point to consider with hollow conductors is the surface roughness inside the bore. With increasing frequencies, the surface roughness has an increasing influence on the signal attenuation that the radar signal experiences when it is guided through the hollow conductor. With the same surface roughness, the attenuation of a hollow conductor can be 0.1 dB/cm at 80 GHz and 1 dB/cm at 250 GHz, for example. For these reasons, hollow conductors are increasingly being replaced by dielectric hollow conductors at higher frequencies. The dielectric hollow conductor consists of a plastic material that predominantly has a low relative permittivity εr and a low loss factor tan(δ). Examples of this are HDPE, PVDF, FEP, and PFA. The cross-section can have various geometries, with round and rectangular geometries being the most common. In addition to advantages such as low signal attenuation, the dielectric hollow conductor also has disadvantages.

In a dielectric hollow conductor, part of the electromagnetic field runs inside the hollow conductor and another part of the field runs outside the hollow conductor. This makes the dielectric hollow conductor susceptible to interference echoes in the vicinity of the hollow conductor. The distribution of how much of the field is on the inside and how much is on the outside of the hollow conductor depends on the geometry of the hollow conductor, the frequency of the radar signal and the plastic used. The dielectric hollow conductor does not have a cut-off frequency in the sense of a hollow conductor.

The rectangular dielectric hollow conductor also has no polarization filtering properties compared to the rectangular hollow conductor. Depending on how the field is coupled in, it is transmitted in this way.

Another fundamental difference between sensors below 100 GHz and above 100 GHz is that the radar signal generated above 100 GHz is fed directly from the signal-generating semiconductors into the hollow conductor. In radar devices below 100 GHz, the radar signal is often first routed via a printed circuit board, which has at least one layer of high-frequency printed circuit board material, before the signal is fed into a hollow conductor or a coaxial conductor. In this case, the transition from PCB to hollow conductor or coaxial conductor is designed in such a way that the desired mode is set in the hollow conductor and all interfering signal frequencies generated by the high-frequency module are filtered out.

For example, multipliers are often used in the high-frequency modules, which multiply a fundamental oscillation to a higher frequency by an integer factor. If, for example, a signal at 240 GHz is required, the circuit 302 in the high-frequency module first generates a fundamental at, for example, 60 GHz, which is then multiplied by a factor of four. Such a circuit is comparatively easy to manufacture. The disadvantage of this is that, in addition to the desired 240 GHz oscillation, signals around 60 GHz and their integer multiples, i.e., 120 GHz, 180 GHz, 300 GHz . . . are also generated. These interfering signals must be suppressed in order to comply with existing and future radio standards. Another example is 80 GHz sensors. Here, for example, the fundamental wave is generated at 40 GHz. The generated signal is fed down from the semiconductor to a printed circuit board via bonding wires 204 and routed to a transition from printed circuit board to hollow conductor. The transition and the subsequent hollow conductor filter out the fundamental wave of 40 GHz so that this oscillation is no longer emitted.

Radar level meters that use frequencies above 100 GHz often couple the signal directly into a dielectric hollow conductor without an additional carrier substrate. For this purpose, there is also a radiating element on the semiconductor material on which the high-frequency circuit is located, which can form a primary radiator in combination with an arrangement of coupling element and resonator element. Such a primary radiator can be used either to couple into a dielectric hollow conductor or to illuminate a dielectric lens. The semiconductor material is often bonded to a carrier circuit board by means of an adhesive layer.

The advantage is that the signal experiences the lowest possible signal attenuation if it no longer has to be routed via a printed circuit board to the transition into the hollow conductor/dielectric hollow conductor. With the combination of this direct coupling and a dielectric hollow conductor, however, there is no implicit filter effect due to the hollow conductor transition or hollow conductor.

In a preferred embodiment, the filter unit comprises a hollow conductor. The hollow conductor can be made of metal. The hollow conductor can be a round hollow conductor. The hollow conductor can be a rectangular hollow conductor. The hollow conductor can be made of plastic coated with metal. The filter characteristic is advantageously set depending on the contour of the hollow conductor, dimensions of the rectangle or bore diameter (i.e., hollow conductor diameter).

In a preferred embodiment, the filter unit comprises a round hollow conductor. The round hollow conductors have a hollow conductor diameter (i.e., through-hole). With increasing frequencies, the hollow conductor diameters become increasingly smaller, as the cutoff frequency of the fundamental mode depends on the hollow conductor diameter. The cut-off frequency is the frequency above which the fundamental mode of the hollow conductor is capable of propagation. If the signal frequency is below the cut-off frequency, no signal transmission takes place as the electromagnetic wave is not capable of propagation. In this case, the wave is reflected at the input of the hollow conductor. A hollow conductor therefore exhibits high-pass behavior. A round hollow conductor can advantageously filter out unwanted modes.

In a preferred embodiment, the filter unit comprises a rectangular hollow conductor. The rectangular hollow conductor has a rectangular hollow conductor cross-section (i.e., continuous pocket). Another difference between the rectangular hollow conductor and the round hollow conductor is that the polarization of the electromagnetic wave is predetermined in the rectangular hollow conductor. The electric field vector is parallel to the short edge of the rectangular hollow conductor. In the circular hollow conductor, on the other hand, the polarization is arbitrary and depends on how the wave is coupled into the circular hollow conductor. Depending on the type of application, this can have advantages and disadvantages. A rectangular hollow conductor can advantageously filter out unwanted modes. A rectangular hollow conductor can advantageously specify a polarization direction. This can ensure that the emitted signal has exactly one polarization direction. This can advantageously guarantee the transmission quality. This can advantageously facilitate the installation of the radar measuring device, as a technician always knows how to install the device.

In a preferred embodiment, the filter unit comprises at least one resonator element for setting a low-pass characteristic. The resonator element is preferably a dielectric resonator element. The resonator element produces a low-pass filter characteristic, i.e., only frequencies below a cut-off frequency can pass through the filter unit. In combination with the hollow conductor, this advantageously creates a bandpass filter. This can have a positive effect on the signal quality.

In a preferred embodiment, the filter unit comprises at least one diaphragm for setting a low-pass characteristic. The diaphragm produces a low-pass filter characteristic, i.e., only frequencies below a cut-off frequency can pass through the filter unit. In combination with the hollow conductor, this advantageously creates a bandpass filter. This can have a positive effect on the signal quality.

In a preferred embodiment, the antenna unit comprises a dielectric lens. The term dielectric lens is to be understood broadly in the present case and preferably means a lens made of a dielectric material that is curved on both sides, which receives radar signals emitted directly or indirectly from the primary radiator and retransmits them in a directed manner or receives reflected radar signals and transmits them directly or indirectly to the primary radiator in a directed manner. The dielectric lens can influence the shape or direction of the radar signals. The dielectric lens preferably has a spherical shape. Depending on a radius or curvature, there is a distance at which the radiation emitted by the dielectric lens (i.e., radar signals) is bundled. The dielectric lens preferably comprises a lossless dielectric material.

In a preferred embodiment, the antenna unit comprises a horn antenna. The term horn antenna is to be understood broadly here and means a funnel-shaped antenna for transmitting and receiving radar signals, which is fed by a hollow conductor.

In a preferred embodiment, the radar measuring device further comprises at least one dielectric hollow conductor element for guiding the radar signals. The dielectric hollow conductor can be made of plastic. Examples of this are HDPE, PVDF, FEP, and PFA. The dielectric hollow conductor can have any geometry as a cross-section. Preferably, the dielectric hollow conductor has a round cross-section or a rectangular cross-section. The plastic preferably has a lower relative permittivity and a low loss factor. This has an overall positive effect on the signal attenuation (i.e., low unwanted signal attenuation) between the primary radiator and the antenna. It also creates galvanic isolation between the process and the sensor electronics. The dielectric hollow conductor element is advantageously suited to carrying high-frequency radar signals, as it causes low attenuation compared to hollow conductors.

In a preferred embodiment, the dielectric hollow conductor element is arranged between the primary radiator and the filter unit. The radar signals between the primary radiator and the filter unit are advantageously guided in both directions via the dielectric hollow conductor element.

In a preferred embodiment, the dielectric hollow conductor element is arranged between the filter unit and the antenna device. The radar signals between the filter unit and the antenna device are advantageously guided in both directions via the dielectric hollow conductor element.

In a preferred embodiment, the radar measuring device is set up to measure at a frequency above 100 GHz.

A further aspect of the present disclosure comprises a system for detecting levels and/or distances, comprising at least one radar measuring device described in more detail above and a container for storing a material.

In a preferred embodiment, the container comprises an agitator.

In a preferred embodiment, the container comprises a heating coil.

### BRIEF DESCRIPTION OF THE FIGURES

A detailed description of the figures is given below.

FIG. 1 shows a schematic view of a system for detecting fill levels according to the present disclosure;

FIG. 2 shows a schematic section of a radar measuring device according to the present disclosure;

FIG. 3 shows a schematic section of a radar measuring device according to the present disclosure;

FIG. 4 shows a schematic section of a radar measuring device according to the present disclosure;

FIG. 5 shows a schematic section of a radar measuring device according to the present disclosure;

FIG. 6 shows a schematic section of a radar measuring device according to the present disclosure;

FIG. 7 shows a schematic section of a radar measuring device according to the present disclosure;

FIG. 8 shows a schematic section of a radar measuring device according to the present disclosure; and

FIG. 9 shows two rectangular hollow conductors with resonator elements and screens.

### DETAILED DESCRIPTION OF EMBODIMENTS

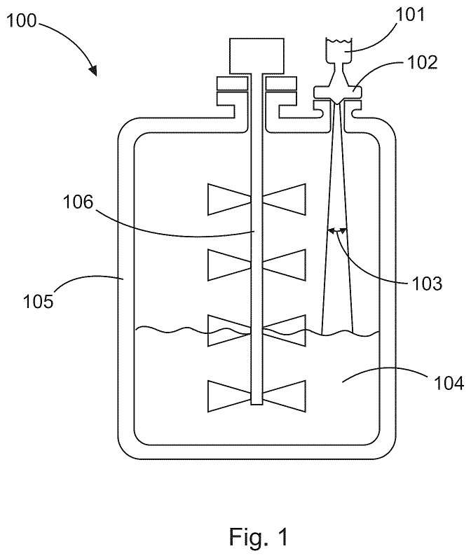

FIG. 1 shows a schematic view of a system 100 according to the present disclosure for detecting fill levels. The system 100 comprises a radar measuring device 101 described in more detail below. The radar measuring device 101 has an antenna 102 in the lower area for transmitting and receiving radar signals. Depending on the measuring frequency, an aperture angle 103 of the radar signals emitted is set. The system also comprises a container 105 for storing a material 104, for example a liquid. The container also comprises an agitator 106. It can be seen from the drawing that the radiation cone resulting from the opening angle 103 does not overlap with the agitator. This has an advantageous effect on the measurement accuracy, as no interfering reflections occur. Furthermore, the system 100 can also include a heating coil (not shown).

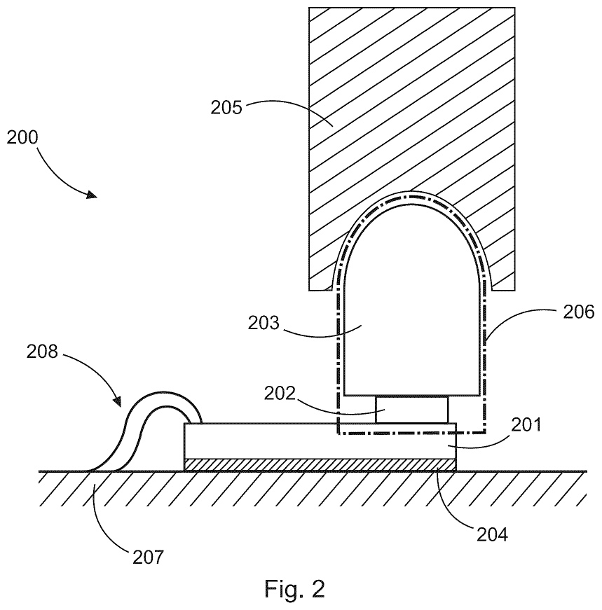

FIG. 2 shows a schematic section of a radar measuring device 200 according to the present disclosure. The radar measuring device comprises at least one carrier plate (i.e., printed circuit board) 207. A semiconductor material 201 is attached to the carrier plate 207 via an adhesive layer 204. A high-frequency circuit (not shown) and a radiator element (not shown) are located on the semiconductor material. A resonator element 202 is located above the radiator element. A coupling element 203, for example made of PEEK, is arranged above the resonator element 202. The coupling element 203, the resonator element 202 and the radiator element in the present case form the primary radiator 206. The semiconductor material 201 is in the present case electrically connected to the carrier plate 207 via bonding wires 208. A dielectric hollow conductor 205 is arranged above the primary radiator 206. The primary radiator 206 transmits the radar signals generated by the frequency circuit to the dielectric hollow conductor 205 or receives the radar signals guided by the dielectric hollow conductor 205 and reflected by the surface of the material.

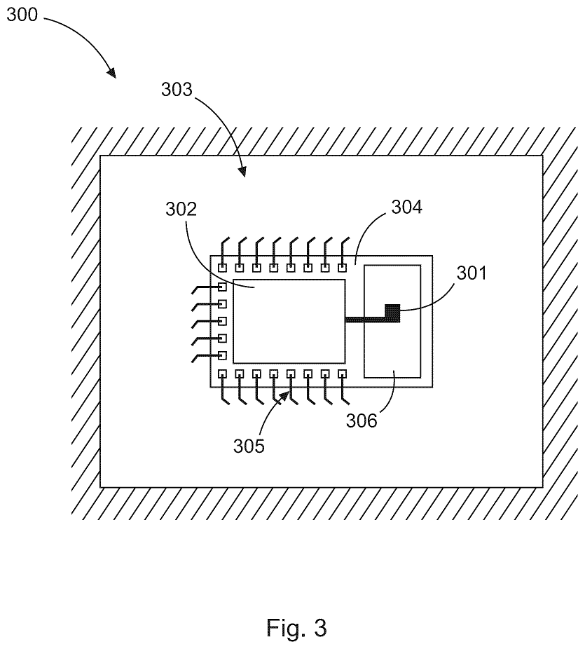

FIG. 3 shows a schematic section of a radar measuring device 300 according to the present disclosure in plan view. The semiconductor material 304 is arranged on the carrier plate 303 and is electrically connected to the carrier plate 303 via the bonding wires 305. The high-frequency circuit 302 and the radiator element 301 are arranged on the semiconductor material 304. The resonator element 306 is arranged above the radiator element 301. The radar signals generated in the high-frequency circuit 302 are forwarded to the radiator element 301, from where they are amplified by the resonator element 306. The radar signals reflected from the surface of the material and the radar signals received by the radar measuring device travel the same path, but in opposite directions.

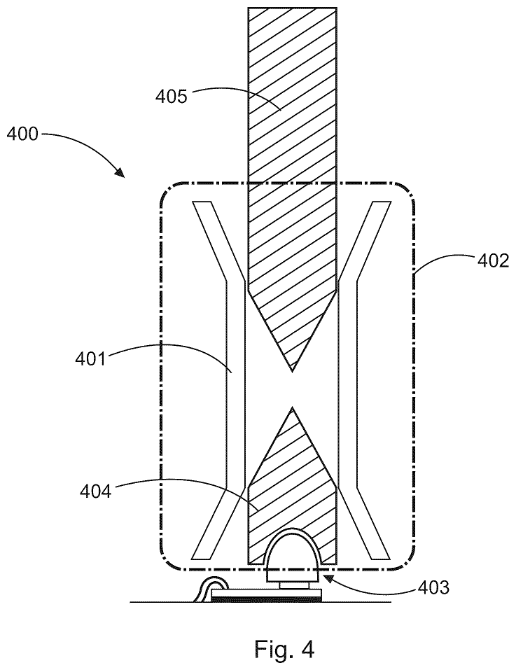

FIG. 4 shows a schematic section of a radar measuring device 400 according to the present disclosure for detecting conditions in containers. The radar measuring device 400 comprises a primary radiator 403 for transmitting and receiving radar signals. In the present case, the primary radiator 403 corresponds to the primary radiator described in FIG. 2. In the present case, the radar measuring device 400 further comprises a two-part dielectric hollow conductor 404 and 405. The radar signal first couples from the primary radiator 403 into the dielectric hollow conductor 404. A filter unit 402 for filtering the radar signals is arranged between the dielectric hollow conductor 404 and the dielectric hollow conductor 405. In the present case, the filter unit is designed as a metallic round hollow conductor 401. The radar signals couple from the metallic hollow conductor 401 into the dielectric hollow conductor 405. The radar signals are forwarded from the dielectric hollow conductor 405 to the antenna unit (not shown) for transmission and reception. The filter unit 402, which is designed as a metallic hollow conductor 401, filters the radar signal with regard to mode and frequency.

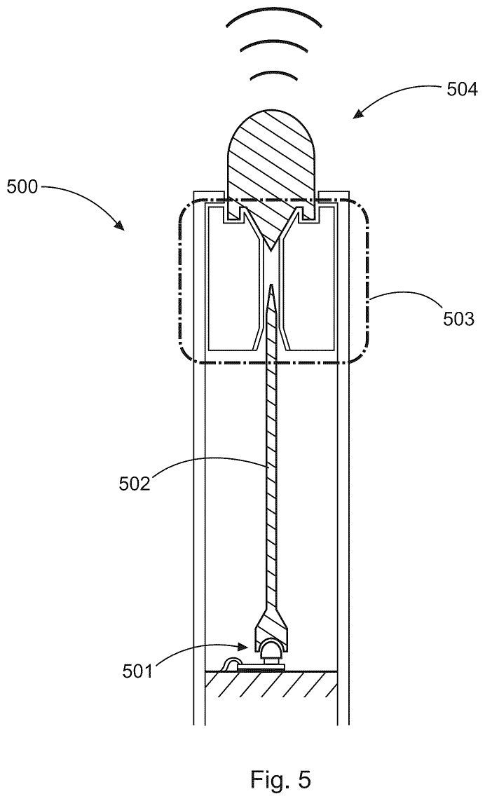

FIG. 5 shows a schematic section of a radar measuring device 500 according to the present disclosure. In the present case, the radar measuring device 500 comprises a primary radiator 501, a dielectric hollow conductor 502, a filter unit 503 and an antenna unit 504. The filter unit 503 is designed as a metallic hollow conductor. The antenna unit 504 is designed as a lens antenna. The filter unit 503 is arranged between the dielectric hollow conductor 502 and the antenna unit 504.

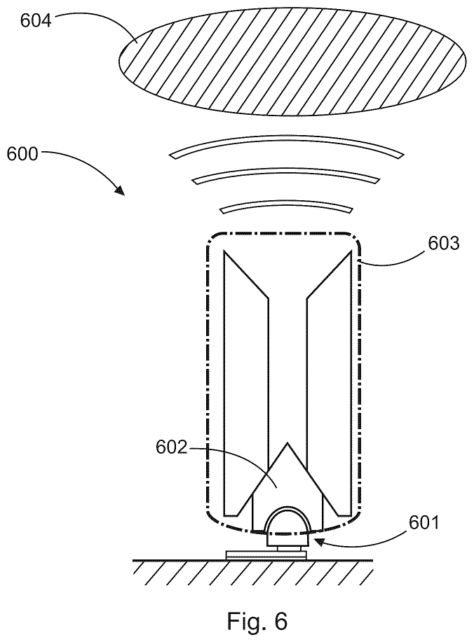

FIG. 6 shows a schematic section of a radar measuring device 600 according to the present disclosure. In the present case, the radar measuring device 600 comprises a primary radiator 601, a dielectric hollow conductor 602, a filter unit 603, and an antenna unit 604. The dielectric hollow conductor 602 is arranged between the primary radiator 601 and the filter unit 603. The hollow conductor unit 603 is designed as a metallic hollow conductor. The antenna unit 604 is designed as a dielectric lens. The filter unit 603 filters the radar signal in terms of frequency and mode. In the present case, the filter unit 603 receives radar signals from the dielectric lens and transmits radar signals to the dielectric lens.

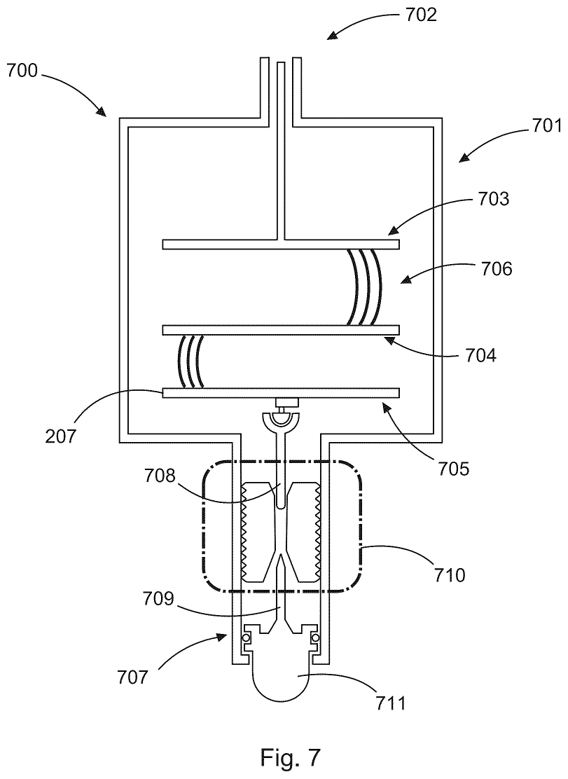

FIG. 7 shows a schematic section of a radar measuring device 700 according to the present disclosure. In contrast to FIG. 5, a metallic housing 701 of the radar measuring device 700 is also shown here. Furthermore, the radar measuring device 700 has an interface 702 for power supply and data exchange, for example an M12 interface. The radar measuring device 600 has a number of carrier plates 703, 704, and 705, which are used for the power supply, the controller, and the high-frequency circuit for generating and processing radar signals. These are electrically connected to each other via plug connectors 706. The radar measuring device 700 has a metallic process connection 707 in the lower area of the housing 701. The dielectric hollow conductors 708 and 709 are arranged in the process connection 707, as are the filter unit 710 and the antenna unit 711. The antenna unit 711 is sealed to the process connection 707. The filter unit 710 is designed as a metallic hollow conductor. The metallic hollow conductor has an external thread for mounting in the process connection 707. The process connection is designed to be connected to a corresponding opening of a container for detecting the fill level.

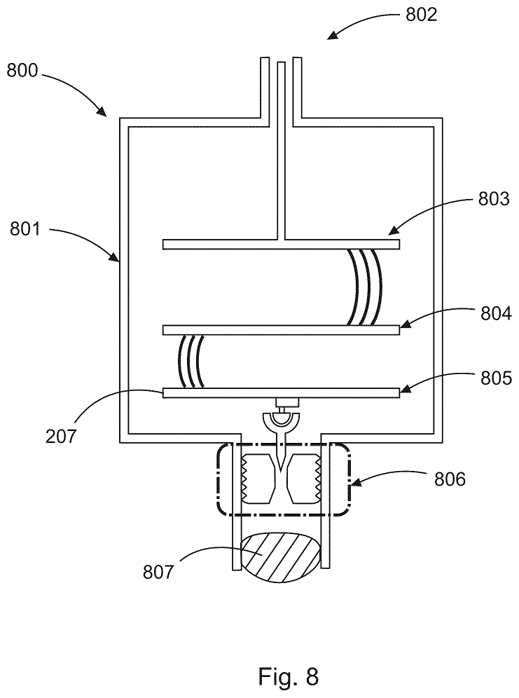

FIG. 8 shows a section of a radar measuring device 800 according to the present disclosure. In contrast to FIG. 6, a housing 801 is also shown here. As already shown in FIG. 7, the interface 802 and the printed circuit boards 803 to 805 are arranged in the housing 801. The filter unit 806 is designed as a metallic hollow cylinder and is arranged in the metallic process connection by means of a thread. The dielectric lens 807 is in turn sealed to the process connection.

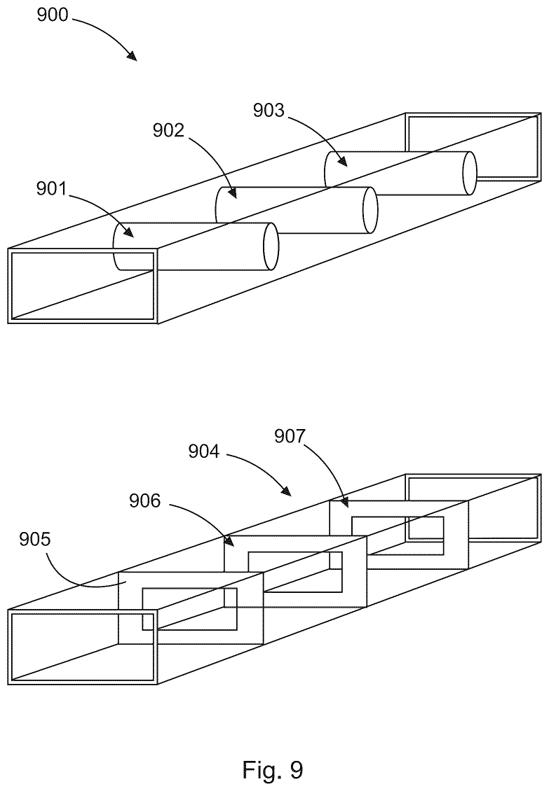

FIG. 9 shows two examples of rectangular hollow conductors. The rectangular hollow conductor 900 has cylindrically shaped dielectric resonator elements 901 to 903, which are arranged inside the cavity. The resonator elements limit the transmission frequency upwards. The rectangular hollow conductor 904 has the diaphragms 905-907, which are arranged inside the cavity. The diaphragms limit the transmission frequency upwards. By using the apertures and/or the resonator elements in conjunction with a rectangular hollow conductor, a band-pass characteristic can be generated for the radar signals in the filter. Such filters can be used to specify the frequency, mode and polarization for the radar signals that pass through the filter.

### REFERENCE LIST

100 System
101, 200, 300, 400, 500, 600, 700, 800 Radar measuring device
102 Antenna device
103 Opening angle
104 Material
105 Container
106 Agitator
201, 304 Semiconductor material
202, 306 Resonator element
203 Coupling element
204 Adhesive layer
205, 404, 405, 502, 602, 708, 709 Dielectric waveguide
206, 403, 501, 601 Primary radiators
207, 303, 703, 704, 705, 803, 804, 805 Support plate
208, 305 Bond wires
401 Round hollow conductor
402, 503, 603, 710, 806 Filter unit
504, 711 Antenna unit
604, 807 Dielectric lens
701, 801 Housing
702, 802 Interface
706 Plug connector
707 Process connection
900, 904 Rectangular hollow conductor 901, 902, 903 905, 906, 907 Resonator Aperture

1. A radar measuring device for determining fill levels and/or distances, comprising:
a primary radiator configured to transmit and to receive radar signals;
an antenna configured to transmit and to receive radar signals; and
a filter configured to filter the radar signals, the filter being arranged between the primary radiator and the antenna.

2. The radar measuring device according to claim 1, wherein the filter comprises a hollow conductor.

3. The radar measuring device according to claim 1, wherein the filter comprises a circular hollow conductor.

4. The radar measuring device according to claim 1, wherein the filter comprises a rectangular hollow conductor.

5. The radar measuring device according to claim 1, wherein the filter comprises at least one resonator element configured to adjust a bandpass characteristic.

6. The radar measuring device according to claim 1, wherein the filter comprises at least one aperture configured to adjust a bandpass characteristic.

7. The radar measuring device according to claim 1, wherein the antenna comprises a dielectric lens.

8. The radar measuring device according to claim 1, wherein the antenna comprises a horn antenna.

9. The radar measuring device according to claim 1, further comprising at least one dielectric waveguide element configured to guide the radar signals.

10. The radar measuring device according to claim 9, wherein the at least one dielectric waveguide element is arranged between the primary radiator and the filter.

11. The radar measuring device according to claim 9, wherein the dielectric waveguide element is arranged between the filter and the antenna.

12. The radar measuring device according to claim 1, wherein the radar measuring device is configured to measure at a frequency above 100 GHz.

13. A system for detecting filling levels and/or distances, comprising at least one radar measuring device according to claim 1 and a container configured to store a material.

14. The system according to claim 13, wherein the container comprises an agitator.

15. The system according to claim 13, wherein the container comprises a heating coil.
